(19) United States
(12) Patent Application Publication
(10) Pub. No.: US 2026/0238280 A1
(43) Pub. Date: Aug. 13, 2026

(54) Frequency Basis Selection for Type-II Codebook Refinement for mTRP Coherent Joint Transmission

(71) Applicant: Apple Inc., Cupertino, CA (US)

(72) Inventors: Haitong SUN, Saratoga, CA (US); Dawei ZHANG, Saratoga, CA (US); Huaning NIU, San Jose, CA (US); Xiang CHEN, Palo Alto, CA (US); Wei ZENG, Saratoga, CA (US); Weidong YANG, San Diego, CA (US)

(21) Appl. No.: 19/156,002

(22) PCT Filed: Jan. 31, 2024
(86) PCT No.: PCT/US2024/013738

§ 371 Date: Aug. 13, 2025

Related U.S. Application Data
(60) Provisional application No. 63/485,094, filed on Feb. 15, 2023.

(51) Int. Cl. H04B 7/06; H04W 72/0453

(52) U.S. Cl. CPC H04B 7/0626; H04B 7/0639; H04W 72/0453

(57) ABSTRACT

An apparatus configured to decode, based on signaling received from a base station, configuration information for reporting Type-II based channel state information (CSI) feedback for Type-II codebook refinement for multi-transmission reception point (TRP) coherent joint transmission (CJT), decode, based on signaling received from the base station, CSI measurement resources and configure transceiver circuitry to transmit the Type-II based CSI feedback for Type-II codebook to the base station.

### BACKGROUND

A user equipment (UE) may connect to a fifth generation (5G) new radio (NR) network. 5G NR may use Type-II codebook refinement for multi-transmission reception point (TRP) coherent joint transmission (CJT). There exists a need for frequency basis selection techniques to support the implementation of Type-II codebook refinement for multi-TRP CJT.

### SUMMARY

Some example embodiments are related to an apparatus having processing circuitry configured to decode, based on signaling received from a base station, configuration information for reporting Type-II based channel state information (CSI) feedback for Type-II codebook refinement for multi-transmission reception point (TRP) coherent joint transmission (CJT), decode, based on signaling received from the base station, CSI measurement resources and configure transceiver circuitry to transmit the Type-II based CSI feedback for Type-II codebook to the base station.

Other example embodiments are related to a method including receiving configuration information for reporting Type-II based channel state information (CSI) feedback for Type-II codebook refinement for multi-transmission reception point (TRP) coherent joint transmission (CJT), receiving CSI measurement resources and transmitting the Type-II codebook based CSI feedback to a base station.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows a signaling diagram for reporting channel state information (CSI) feedback according to various example embodiments.

### DETAILED DESCRIPTION

The example embodiments may be further understood with reference to the following description and the related appended drawings, wherein like elements are provided with the same reference numerals. The example embodiments relate to Type-II codebook refinement for multi-transmission reception point (TRP) coherent joint transmission (CJT).

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any electronic component.

The example embodiments are also described with regard to a fifth generation (5G) New Radio (NR) network and a next generation node B (gNB). However, reference to a 5G NR network and a gNB is merely provided for illustrative purposes. The example embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The example embodiments are described with regard to multi-TRP (mTRP) operation. From the perspective of the UE, multi-transmission reception point (mTRP) operation may include establishing and maintaining a connection with multiple TRPs at the same time. For example, different channel state information (CSI)-reference signals (RS) resource sets may be configured for different TRPs to support CSI measurement.

In 5G NR, a Type-II MIMO codebook may be based on a W₁*W₂*W_{f} structure where W₁ represents a spatial basis selection, W₂ represents a frequency basis selection and W_{f} represents a combination coefficient. An example of which is shown below.

$$\begin{matrix}[ {w}^{ℓ} ( 1 ) & … & {w}^{ℓ} ( {N}_{3} ) ] = {\overleftrightarrow{( \begin{matrix}\begin{matrix}{v}_{0} & … & {v}_{L - 1}\end{matrix} & \\ & \begin{matrix}{v}_{0} & … & {v}_{L - 1}\end{matrix}\end{matrix} )}}^{2 L}\end{matrix} {\overleftrightarrow{( \begin{matrix}{\tilde{c}}_{0 , 1 , ℓ} & … & {\tilde{c}}_{0 , M , ℓ} \\ ⋮ & ⋱ & ⋮ \\ {\tilde{c}}_{2 L - 1 , 1 , ℓ} & … & {\tilde{c}}_{2 L - 1 , M , ℓ}\end{matrix} )}}^{M} ( \begin{matrix}{w}_{f , 1}^{H} \\ ⋮ \\ {w}_{f , M}^{H}\end{matrix} )$$

$${W}^{ℓ} \qquad {W}_{1} \qquad {W}_{2}^{ℓ} \qquad {W}_{f}^{H}$$

$$Spatial basis \qquad \begin{matrix}Compressed \\ combination coefficients\end{matrix} \qquad \begin{matrix}M frequency \\ basis\end{matrix}$$

In the above example, M represents the number of selected frequency basis, L represents the number of selected spatial basis, N₃ represents the number of subbands in the frequency domain and [symbol] represents the layer index. Those skilled in the art will understand how the parameters and operations shown in the above example may be computed.

For release 18 (Rel-18), 5G NR may support Type-II codebook refinement for mTRP coherent joint transmission (CJT) with mode 1 and mode 2. Mode 1 refers to an independent frequency basis selection across N TRPs/TRP groups. An example formulation of a Type-II codebook for CJT mTRP mode 1 may be represented as follows:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ]$$

Mode 2 refers to a joint/common frequency basis selection across all TRPs/TRP groups (e.g., W_{f}). An example formulation of a Type-II codebook for CJT mTRP mode 2 may be represented as follows:

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ]$$

As will be described in more detail below, the example embodiments relate to different aspects of frequency basis selection for CJT such as the number of selected frequency basis, performing the frequency basis selection and toggling between independent and common frequency basis selection (e.g., mode 1 and mode 2). The example embodiments may be used in independently from one another, in conjunction with currently implemented mechanisms for Type-II codebook refinement for mTRP CJT, in conjunction with future implementations of mechanisms for Type-II codebook refinement for mTRP CJT or independently from other mechanisms for Type-II codebook refinement.

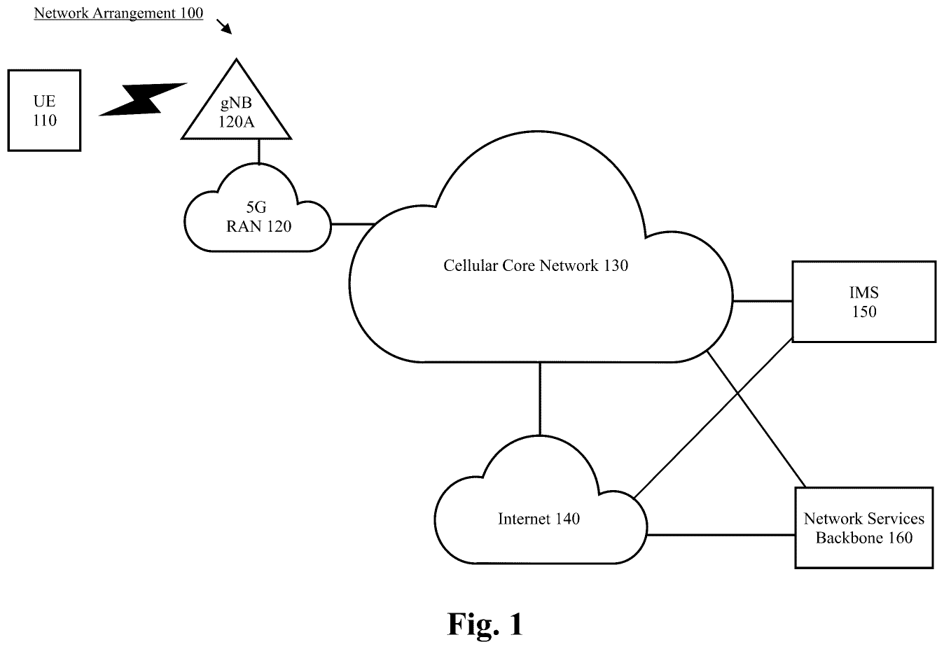

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

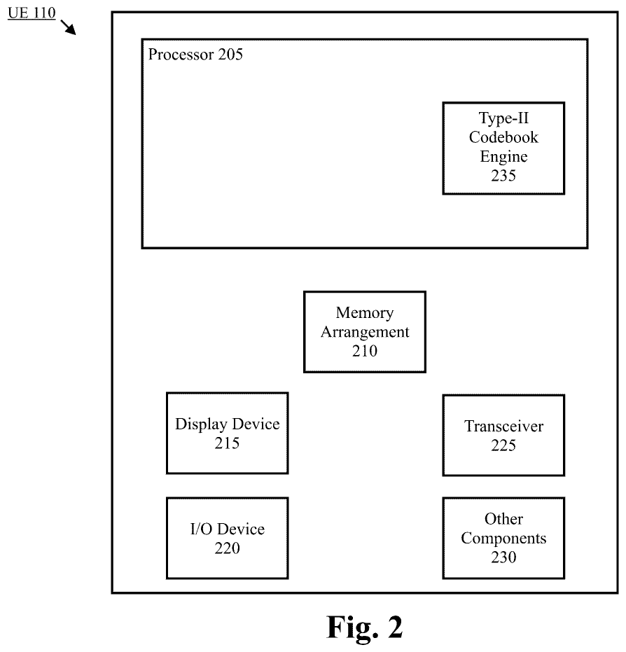

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a Type-II codebook engine 235. The Type-II codebook engine 235 may perform various operations related to the example embodiments introduced herein, such as, but not limited to, determining a number of frequency basis for frequency basis selection for Type-II codebook refinement for mTRP CJT, performing frequency basis selection for Type-II codebook refinement for mTRP CJT, reporting CSI and toggling between independent and common frequency basis selection mechanisms for Type-II codebook refinement for mTRP CJT.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

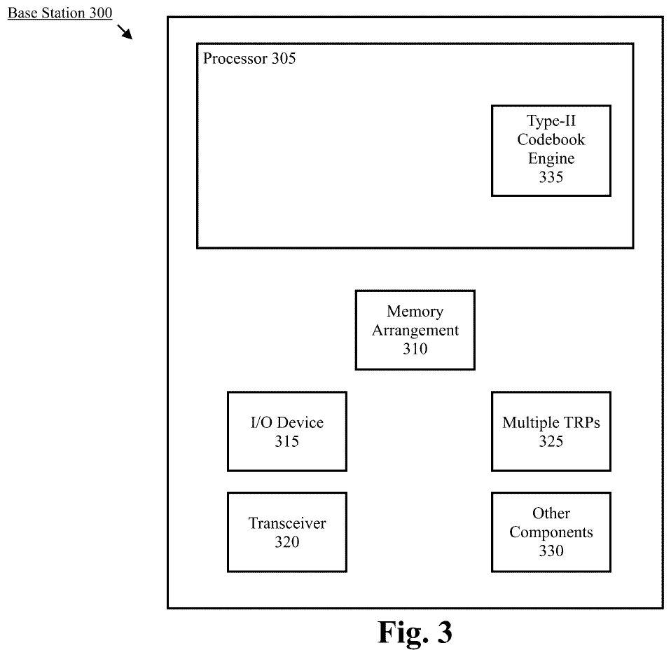

FIG. 3 shows an example base station 300 according to various example embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 330 may include, for example, an audio input device, an audio output device, a battery, a data acquisition device, ports to electrically connect the base station 300 to other electronic devices and/or power sources, TxRUS, transceiver chains, antenna elements, antenna panels, etc.

As indicated above, in some scenarios, the multiple TRPs 325 may be deployed locally at the base station 300. In other scenarios, one or more of the multiple TRPs 325 may be deployed at physical locations remote from the base station 300 and connected to the base statin via a backhaul connection. The base station 300 may be configured to control the multiple TRPs 325 and perform operations such as, but not limited to, assigning resources, configuring reference signals, implementing beam management techniques, etc.

The processor 305 may be configured to execute a plurality of engines for the base station 300. For example, the engines may include a Type-II codebook engine 335. The Type-II codebook engine 335 may perform operations related to the example embodiments introduced here such as, but not limited to, transmitting configuration information for Type-II codebook refinement, transmitting CSI measurement resources and receiving a CSI report.

The above noted engine 335 being an application (e.g., a program) executed by the processor 305 is only example. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

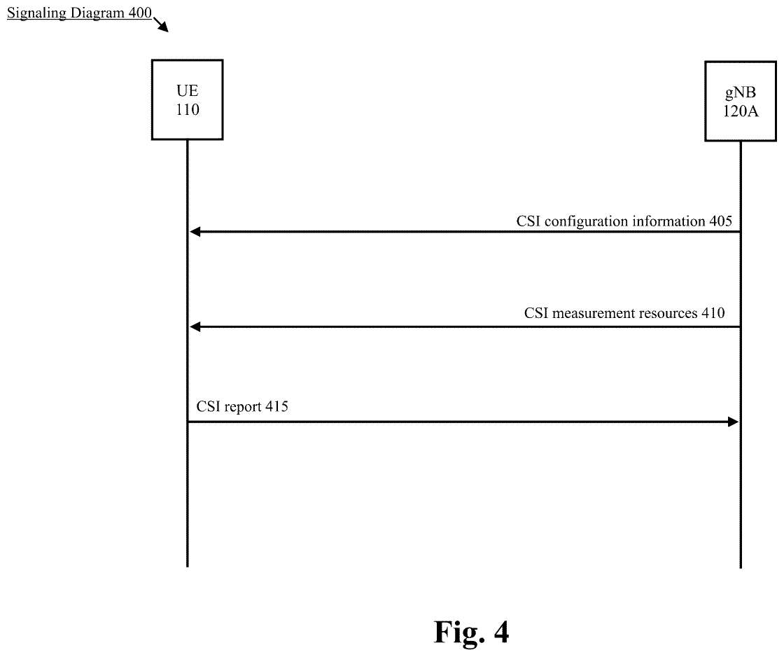

FIG. 4 shows a signaling diagram 400 for reporting CSI feedback according to various example embodiments. The signaling diagram 400 is described with regard to the network arrangement 100 of FIG. 1, the UE 110 of FIG. 2 and the base station 300 of FIG. 3.

The signaling diagram 400 is described with regard to a scenario in which the UE 110 reports CSI feedback to the gNB 120A. Initially, a general overview of this example scenario is described below to provide context for the example embodiments introduced herein. The example embodiments include techniques for determining a number of frequency basis to be selected, performing a frequency basis selection and toggling between an independent and common frequency basis selection mechanism. Each of these example enhancements will be described in detail below after the description of the signaling diagram 400.

In 405, the UE 110 receives CSI configuration information from the gNB 120A. The configuration information may include, but is not limited to, configuration information for CSI measurement resources, the type of CSI to be reported and CSI reporting parameters, e.g., periodicity and slot offset.

The CSI configuration information may be provided to the UE 110 in one or more Radio Resource Control (RRC) messages. However, the example embodiments are not limited to RRC messages, CSI configuration information may be provided in any appropriate type of message (e.g., medium access control (MAC) control element (CE), downlink control information (DCI), etc.).

The CSI configuration information may include configuration information for the CSI measurement resources. The CSI measurement resources may be provided using synchronization signal block (SSB), CSI-reference signal (RS) or any other appropriate type of signal. The periodicity and offset of these resources may be characterized in slots or in any other appropriate manner. Throughout this description, any reference to a particular type of CSI measurement resource is merely provided for illustrative purposes, the example embodiments may apply to any appropriate type of CSI measurement resource.

In 410, the UE 110 receives CSI measurement resources. In the signaling diagram 400, the CSI measurement resources are transmitted by the gNB 120A. However, in an actual deployment scenario, the UE 110 may receive CSI measurement resources from multiple serving cells including serving cells deployed by a gNB or base station other than the gNB 120A.

In 415, the UE 110 transmits a CSI report to the gNB 120A. The contents of the CSI report and the transmission of the CSI report may be based on the CSI configuration information provided by the gNB 120A in 405. A CSI report may include one or more different types of CSI (e.g., precoding matrix indicator (PMI), channel quality indicator (CQI), etc.) derived based on CSI measurement resources.

As indicated above, COI may be included in a CSI report. The COI may indicate a UE estimated signal to interference and noise ratio (SINR) and/or a preferred modulation and coding scheme (MCS). The network may then consider the reported CQI to ensure that a subsequent downlink transmission is adequately configured for the given channel conditions. In addition, PMI may be included in a CSI report to indicate a UE preferred precoder. However, the gNB 120A is not required to utilize the UE preferred precoder and may select a different precoder for subsequent downlink transmissions. The gNB 120A may inform the UE 110 of the selected precoder using DCI or any other appropriate type of signal.

For Type-II codebook, there may be multiple reporting opportunities for a CSI report at different time instances that are configured by the network. The example embodiments introduced below may be utilized in conjunction with any appropriate currently implemented CSI reporting mechanisms or future implementations of a CSI reporting mechanism or independently from other CSI reporting mechanisms.

Alternatively, or in addition to RRC messages, CSI configuration information may be provided in a MAC CE, DCI or any other appropriate type of signal. For example, a MAC CE and/or DCI may be configured to activate and deactivate sets of CSI measurement resources, indicate a CSI report periodicity and slot offset, indicate a codebook type (e.g., mode 1, mode 2, etc.), change a configuration of a CSI parameter previously configured by an RRC message or provide any other type of configuration information relevant to reporting CSI.

As mentioned above, a type II MIMO codebook may be based on a W₁*W₂*W_{F} structure where W₁ represents a spatial basis, W_{f} represents a frequency basis and W₂ represents a compressed combination coefficient. Each of these matrices (W₁, W₂, W_{F}) are defined in various 3GPP Specifications and documents. In this description, these matrices may be used in the manner in which they are defined in the 3GPP Specifications and documents and may be modified in accordance with the example embodiments described herein.

According to some aspects, the example embodiments relate to the number of selected frequency basis for Type-II codebook refinement for mTRP CJT. For frequency basis selection, the length of each frequency basis N₃ (e.g., each frequency basis contains N₃ entries) may be a function of the number of channel CQI subbands configured in the CSI reporting band for the UE 110 to perform CSI reporting. The intended number of PMI subbands per CQI may be represented by factor R. In some embodiments, R may be either 1 or 2 where support for R=2 is optional for UEs that support Type-II codebook refinement for mTRP CJT. In other embodiments, R is limited to 1. In addition, there may be a total of N₃ orthogonal frequency basis (each with a length of N₃) for UE selection.

In some embodiments, one group of N₃ orthogonal frequency basis may be supported for frequency basis selection. The n^{th} frequency basis may be

$$exp \{ j \cdot 2 π \cdot i \cdot \frac{n}{{N}_{3}} \} , i , n = 0 , 1 , ... , {N}_{3} - 1.$$

In other embodiments, multiple groups (O₃) of N₃ orthogonal frequency basis may be supported for frequency basis selection. The n^{th} frequency basis in the O^{th} group may be

$$exp \{ j \cdot 2 π \cdot i \cdot \frac{\frac{n \cdot {O}_{3} + o}{{N}_{3}}}{{O}_{3}} \} , i , n = 0 , 1 , ... , {N}_{3} - 1 , o = 0 , ... , {O}_{3} .$$

In another approach, the network may configure a maximum number of frequency basis (M) for frequency basis selection. M may be configured as a percentage of the total number of orthogonal frequency basis (ρ) such that

$$M = ⌈ p \cdot \frac{{N}_{3}}{R} ⌉$$

or M=[p·N₃]. The network may configures one of multiple predefined parameter sets where each parameter sets maps to one or multiple values of p. When one value of p is mapped to a parameter set, the value of p may apply to all of the reported rank. When multiple values of p are mapped to a parameter set, different values of may be apply to different reported rank.

In other embodiments, the network may configure a maximum number of frequency basis (M) for frequency basis selection where M applies to each TRP or TRP group. In this example, the same M may be applied to each TRP/TRP group or a different M may be configured for different TRP/TRP group. In another embodiments, the network may configure a maximum number of frequency basis (M) for frequency basis selection where M applies to all TRPs or TRP groups.

After the network configures the maximum number of frequency basis (M) for frequency basis selection, for the CSI report, the UE 110 may select an actual number of frequency basis that is less than or equal to M (e.g., \tilde{M}≤M). In this scenario, the UE 110 may report the number of selected frequency basis in CSI part 1 or CSI part 2 group 0. Alternatively, the UE 110 may select the actual number of frequency basis for CSI reporting (e.g., \tilde{M}=M). In this scenario, the UE 110 may not report the number of selected frequency basis in the CSI.

For CSI reporting, in some embodiments, a same number of frequency basis may be selected for different TRP or TRP group. In other embodiments, a different number of frequency basis may be selected for different TRPs or TRP groups.

According to some aspects, the example embodiments relate to performing the frequency basis selection. For the following example embodiments, assume a scenario in which a number of frequency basis are selected (M) for a particular TRP or TRP. In some embodiments, the first frequency basis is always selected. For this approach, the selection of the first frequency basis may not be reported in the CSI. However, the selected remaining \tilde{M}−1 frequency basis are reported in the CSI. In other embodiments, the first frequency basis does not always need to be selected. For this approach, the selected \tilde{M} frequency basis are reported in the CSI.

A delay in time is a phase ramp in frequency. To handle the different delay from different TRPs or TRP groups the UE 110 may further report the phase ramp correction parameter φ for each TRP or TRP group. The phase ramp correction may be applied to i^{th}, i=0, 1, . . . N₃−1 entry of every selected frequency basis as Xᵢ·exp{j·φ·i}.

In another approach, to handle the different delay from different TRPs or TRP groups, a reference TRP or TRP group may be selected with a phase ramp correction parameter φ=0. The phase ramp parameter φ may not be reported for the reference TRP or TRP group. However, the UE 110 may report the phase ramp parameters φ for the remaining TRP or TRP groups.

In some embodiments, to select the reference TRP or TRP group, the first TRP or TRP group is always selected. The phase ramp parameter φ for the other TRPs or TRP groups may be positive or negative value. In other embodiments, the UE 110 may select and report the reference TRP or TRP group. For this approach, the phase ramp parameter φ for the other TRPs or TRP groups may all be either negative values or positive values. Whether a positive or negative sign is used for these parameters may be predetermined.

For frequency basis selection, the number of frequency basis \tilde{M} may be selected from a subset of Ñ₃≤N₃ frequency basis. In some embodiments, the subset of Ñ₃ frequency basis may be consecutive, e.g., for a total N₃ frequency basis the 1^{st} and

$${N}_{3}^{th}$$

frequency basis may be considered to be consecutive. In other embodiments, the subset of Ñ₃ frequency basis may be non-consecutive.

Whether to select a frequency basis from a smaller subset may depend on N₃. When N₃ is relatively small (e.g., N_3≤19), selection may be done over Ñ₃=N₃ frequency basis. When N₃ is relatively large (e.g., N₃>19) selection may be done over a subset of Ñ₃<N₃ frequency basis.

When the frequency basis selection is performed over a smaller subset of Ñ₃<N₃ frequency basis, Ñ₃ may be determined based on one of the following options. In one option, Ñ₃ may be determined based on the maximum number of selected frequency configured by the network (e.g., Ñ₃=2M). In another option, Ñ₃ may be determined based on the actual number of selected frequency configured by the network (e.g., Ñ₃=2\tilde{M}). In another option, Ñ₃ may be determined based on a percentage of the total number of frequency basis N₃ (e.g., Ñ₃=[r·N₃] or Ñ₃=[r·N₃]).

In addition, when the frequency basis selection is performed over a smaller subset of Ñ₃<N₃ frequency basis, which Ñ₃ frequency basis included in the subset may be reported by the UE 110. For instance, when configured to use consecutive Ñ₃ frequency basis, the location of the first frequency basis may be reported. In some embodiments, the first frequency basis may be required to be in the subset. In another approach, which Ñ₃ frequency basis included in the subset may be predetermined and hard encoded in 3GPP specifications. For example, it may be predetermined to always report the Ñ₃ frequency basis.

According to some aspects, the example embodiments introduce techniques for toggling between independent and common frequency basis selection (e.g., mode 1 and mode 2). In one option, the selection of mode 1 or mode 2 may be configured by the network via radio resource control (RRC). In another option, the selection of mode 1 or mode 2 may be configured by the network via downlink control information (DCI) and/or a medium access control (MAC) control element (CE).

In another option, the selection of mode 1 or mode 2 may be reported by the UE 110 dynamically in CSI. With this approach, a 1-bit mode indication may be introduced for the CSI reported by the UE 110. The 1-bit mode indication may be reported either in CSI part 2 group 0 or CSI part 1. Alternatively, uplink control information (UCI) omission may be used to toggle between mode 1 and mode 2. With this approach, the common frequency basis selection of one TRP or TRP group may be reported in UCI part 2 group 1. The independent frequency basis selection for the other TRPs or TRP groups may be reported in UCI part 2 group 2.

### Examples

In a first example, a method comprising receiving configuration information for reporting Type-II based channel state information (CSI) feedback for Type-II codebook refinement for multi-transmission reception point (TRP) coherent joint transmission (CJT), receiving CSI measurement resources and transmitting the Type-II codebook based CSI feedback to a base station.

In a second example, the method of the first example, wherein a length of each frequency basis for Type-II codebook refinement for multi-TRP CJT is a function of a number of channel quality indicator (CQI) subbands configured by a network for CSI reporting.

In a third example, the method of the second example, wherein an intended number of precoding matrix indicator (PMI) subbands per COI is a factor of one or two.

In a fourth example, the method of the first example, wherein one group comprising a number of subbands in a frequency domain are used for frequency basis selection for Type-II codebook refinement for multi-TRP CJT.

In a fifth example, the method of the first example, wherein multiple groups each comprising a number of subbands in a frequency domain may be used for frequency basis selection for Type-II codebook refinement for multi-TRP CJT.

In a sixth example, the method of the first example, wherein the configuration information includes a maximum number of frequency basis for UE selection.

In a seventh example, the method of the sixth example, wherein the maximum number of frequency basis for UE selection is a percentage of a total number of orthogonal frequency basis.

In an eighth example, the method of the seventh example, wherein the total number of orthogonal frequency basis maps to one parameter set and wherein the value of the total number of orthogonal frequency basis applies to all reported rank.

In a ninth example, the method of the seventh example, wherein multiple values of the total number of orthogonal frequency basis are mapped to a parameter set and wherein different values for the total number of orthogonal frequency basis are applied to different reported rank.

In a tenth example, the method of the sixth example, wherein the maximum number of frequency basis for UE selection applies to each TRP or TRP group.

In an eleventh example, the method of the sixth example, where the maximum number of frequency basis for UE selection applies to a first TRP or TRP group and a second different maximum number of frequency basis for UE selection applies to a second different TRP or TRP group.

In a twelfth example, the method of the sixth example, wherein the UE selects an actual number of frequency basis that is less than or equal to the maximum number of frequency basis configured by the network.

In a thirteenth example, the method of the twelfth example, wherein the actual number of frequency basis is reported in CSI part 1 or CSI part 2 group 0.

In a fourteenth example, the method of the sixth example, wherein the UE selects the maximum number of frequency basis configured by the network and wherein a number of selected frequency basis are not reported in the CSI feedback by the UE.

In a fifteenth example, the method of the sixth example, wherein a same number of frequency basis is selected for each TRP or TRP group.

In a sixteenth example, the method of the sixth example, wherein a different number of frequency basis is selected for different TRPs or TRP groups.

In a seventeenth example, the method of the first example, wherein a number of frequency basis are selected for a TRP or TRP group.

In an eighteenth example, the method of the seventeenth example, wherein a selection of a first frequency basis is not reported in the CSI feedback and a remaining number of frequency basis are reported in the CSI feedback and wherein the first frequency basis and the remaining number of frequency basis are equal to the number of frequency basis selected for the TRP or TRP group.

In a nineteenth example, the method of the seventeenth example, wherein the selected frequency basis are reported in the CSI feedback.

In a twentieth example, the method of the first example, wherein the UE reports a phase ramp correction term for each TRP or TRP group.

In a twenty first example, the method of the first example, wherein the phase ramp correction term corresponds to one reference TRP or TRP group and wherein the UE does not report the phase ramp correction term for the reference TRP or TRP group.

In a twenty second example, the method of the twenty first example, wherein the UE reports a phase ramp correction term for each TRP or TRP group except for the reference TRP or TRP group.

In a twenty third example, the method of the twenty first example, wherein a first TRP or TRP group is selected as the reference TRP or TRP group.

In a twenty fourth example, the method of the twenty first example, further comprising selecting one TRP or TRP group as the reference TRP or TRP group and reporting the selected TRP or TRP group as the reference TRP or TRP group to the network.

In a twenty fifth example, the method of the first example, wherein a number of frequency basis are selected from a subset of consecutive frequency basis.

In a twenty sixth example, the method of the first example, wherein a number of frequency basis are selected from a subset of non-consecutive frequency basis.

In a twenty seventh example, the method of the first example, wherein when a number of subbands in the frequency domain (N₃) is less than or equal to 19, frequency basis selection is over Ñ₃=N₃ frequency basis and when N₃ is greater than 19 frequency basis selection is over a subset of Ñ₃≤N₃ frequency basis.

In a twenty eighth example, the method of the first example, wherein a number of frequency basis are selected for a TRP or TRP group from a subset of frequency basis and an actual number of selected frequency basis selected from the subset are based on a maximum number of selected frequency configured by a network.

In a twenty ninth example, the method of the first example, wherein a number of frequency basis are selected for a TRP or TRP group from a subset of frequency basis and an actual number of selected frequency basis selected from the subset are based on a number of selected frequency configured by a network.

In a thirtieth example, the method of the first example, wherein a number of frequency basis are selected for a TRP or TRP group from a subset of frequency basis and an actual number of selected frequency basis selected from the subset are based on a percentage of a total number of frequency basis.

In a thirty first example, the method of the first example, wherein a number of frequency basis are selected for a TRP or TRP group from a subset of frequency basis are reported by the UE.

In a thirty second example, the method of the first example, wherein a number of frequency basis are selected for a TRP or TRP group from a subset of frequency basis are predetermined.

In a thirty third example, the method of the first example, further comprising determining whether to use mode 1 or mode 2 for Type-II codebook refinement for mTRP CJT based on a signal from the network, wherein the signal is one of radio resource control (RRC), medium access control (MAC) control element (CE) or downlink control information (DCI).

In a thirty fourth example, the method of the first example, wherein the UE reports whether mode 1 or mode 2 was used for Type-II codebook refinement for mTRP CJT in CSI.

In a thirty fifth example, the method of the thirty fourth example, wherein the CSI comprises a 1-bit indicator in CSI part 2 group 0 configured to indicate whether mode 1 or mode 2 was used for Type-II codebook refinement for mTRP CJT.

In a thirty sixth example, the method of the thirty fourth example, wherein the CSI comprises a 1-bit indicator in CSI part 1 configured to indicate whether mode 1 or mode 2 was used for Type-II codebook refinement for mTRP CJT.

In a thirty seventh example, the method of the first example, wherein the UE reports that mode 2 was used for Type-II codebook refinement for mTRP CJT in uplink control information (UCI) part 2 group 1.

In a thirty eighth example, the method of the first example, wherein the UE reports that mode 1 was used for Type-II codebook refinement for mTRP CJT in uplink control information (UCI) part 2 group 2.

In a thirty ninth example, a processor configured to perform any of the first through thirty eight examples.

In a fortieth example, a user equipment (UE) comprising a transceiver configured to communicate with a network and a processor communicatively coupled to the transceiver and configured to perform any of the first through thirty eight examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
decode, based on signaling received from a base station, configuration information for reporting Type-II based channel state information (CSI) feedback for Type-II codebook refinement for multi-transmission reception point (TRP) coherent joint transmission (CJT);
decode, based on signaling received from the base station, CSI measurement resources; and
configure transceiver circuitry to transmit the Type-II based CSI feedback for Type-II codebook to the base station.

2. The apparatus of claim 1, wherein a length of each frequency basis for Type-II codebook refinement for multi-TRP CJT is a function of a number of channel quality indicator (CQI) subbands configured by a network for CSI reporting.

3. The apparatus of claim 2, wherein an intended number of precoding matrix indicator (PMI) subbands per CQI is a factor of one or two.

4. The apparatus of claim 1, wherein one group comprising a number of subbands in a frequency domain are used for frequency basis selection for Type-II codebook refinement for multi-TRP CJT.

5. The apparatus of claim 1, wherein multiple groups each comprising a number of subbands in a frequency domain may be used for frequency basis selection for Type-II codebook refinement for multi-TRP CJT.

6. The apparatus of claim 1, wherein the configuration information includes a maximum number of frequency basis for selection by the apparatus.

7. The apparatus of claim 6, wherein the maximum number of frequency basis for selection by the apparatus is a percentage of a total number of orthogonal frequency basis.

8. The apparatus of claim 7, wherein the total number of orthogonal frequency basis maps to one parameter set and wherein a value of the total number of orthogonal frequency basis applies to all reported rank.

9. The apparatus of claim 7, wherein multiple values of the total number of orthogonal frequency basis are mapped to a parameter set and wherein different values for the total number of orthogonal frequency basis are applied to different reported rank.

10. The apparatus of claim 6, wherein the maximum number of frequency basis for selection by the apparatus applies to each TRP or TRP group.

11. The apparatus of claim 6, where the maximum number of frequency basis for selection by the apparatus applies to a first TRP or TRP group and a second different maximum number of frequency basis for selection by the apparatus applies to a second different TRP or TRP group.

12. The apparatus of claim 6, wherein the apparatus selects an actual number of frequency basis that is less than or equal to the maximum number of frequency basis configured by a network.

13. The apparatus of claim 6, wherein the apparatus selects the maximum number of frequency basis configured by a network and wherein a number of selected frequency basis are not reported in the CSI feedback.

14. The apparatus of claim 6, wherein a same number of frequency basis is selected for each TRP or TRP group.

15. The apparatus of claim 1, wherein the apparatus reports a phase ramp correction term for each TRP or TRP group.

16. The apparatus of claim 15, wherein the phase ramp correction term corresponds to one reference TRP or TRP group and wherein the apparatus does not report the phase ramp correction term for the reference TRP or TRP group.

17. The apparatus of claim 16, wherein the apparatus reports a phase ramp correction term for each TRP or TRP group except for the reference TRP or TRP group.

18. The apparatus of claim 16, wherein a first TRP or TRP group is selected as the reference TRP or TRP group.

19. The apparatus of claim 16, wherein the processing circuitry is further configured to:
select one TRP or TRP group as the reference TRP or TRP group; and
report the selected TRP or TRP group as the reference TRP or TRP group to a network.

20. The apparatus of claim 1, wherein the processing circuitry is further configured to:
determine whether to use mode 1 or mode 2 for Type-II codebook refinement for mTRP CJT based on a signal from a network, wherein the signal is one of radio resource control (RRC), medium access control (MAC) control element (CE) or downlink control information (DCI).
